(19) United States
(12) Patent Application Publication
(10) Pub. No.: US 2026/0302465 A1
(43) Pub. Date: Oct. 1, 2026

(54) BATTERY ENCLOSURE

(71) Applicant: Dyson Technology Limited, Malmesbury, Wiltshire (GB)

(72) Inventors: Sean CREED, Chippenham (GB); James Thomas WRIGHT, Bristol (GB); Edward Hugh BURDEN, Stroud (GB); Ali AL-RUBEI, Swindon (GB)

(21) Appl. No.: 19/477,820

(22) PCT Filed: Apr. 10, 2024
(86) PCT No.: PCT/IB2024/053494

§ 371 Date: Oct. 23, 2025

(30) Foreign Application Priority Data
Apr. 27, 2023 (GB) 2306190.6

(51) Int. Cl. H01M 50/211; H01M 50/224; H01M 50/242; H01M 50/291; H01M 50/293

(52) U.S. Cl. CPC H01M 50/211; H01M 50/224; H01M 50/242; H01M 50/291; H01M 50/293

(57) ABSTRACT

A battery including one or more pouch cells and a pouch cell enclosure. The pouch cell enclosure includes first and second walls that are spaced apart in a cell stack direction to define a cell-receiving space therebetween in which the one or more pouch cells are received. The pouch cell enclosure also includes a spring arrangement including a first end at the second wall and a second end extending into the cell-receiving space to engage the one or more pouch cells. The spring arrangement is compressible from an expanded configuration to a compressed configuration in which the distance between the first and second ends of the spring arrangement is reduced in the cell stack direction. The spring arrangement includes a resilient spring element that bends in response to compression of the spring arrangement and to bias the spring arrangement towards the expanded configuration.

### BACKGROUND

Batteries, such as those used in consumer devices, are typically formed of a plurality of battery cells (or just “cells”). Battery cells (such as lithium-ion cells) come in various formats. Known battery cells often have a cylindrical shape or a rectangular (or cuboid) shape. One type of rectangular battery cell that is increasingly being used in devices is a pouch cell. A pouch cell includes a laminated battery architecture contained within a flexible (i.e. non-rigid) pouch, which is commonly formed of a plastic coated aluminium film. Tabs are provided at one end (or two opposite ends) of the pouch cell to provide terminals that allow electrical connection of the pouch cell to other pouch cells in a pouch cell stack or to the electrical components of a device.

The use of a pouch rather than a rigid housing (as is the case with other types of battery cell) reduces the overall weight and volume of the cell. Likewise, the rectangular (or cuboid) shape provides a more efficient use of space than a cylindrical shape when multiple cells are packaged together. (i.e. in a cell stack)

The flexible nature of the pouch of a pouch cell, however, means that an enclosure must be provided to protect the pouch cell (or a stack of pouch cells) of a battery against damage. One characteristic of pouch cells (such as lithium-ion pouch cells) is that each charge and discharge cycle of the pouch cell can result in expansion and contraction of the pouch cell. Likewise, for performance reasons, it is desirable to maintain compression of pouch cells through each charge and discharge cycle. Thus, pouch cells must be packaged in a way that accommodates this expansion and contraction while maintaining compression.

To achieve this, pouch cell stacks are typically packaged in a rigid enclosure with foam provided between each cell, and between the outermost cells and the enclosure (i.e. the foam is typically arranged in series with the pouch cells). As the cells expand, the foam is compressed, which provides a reactionary force to maintain compression of the cells.

### SUMMARY

In a first aspect there is disclosed a pouch cell enclosure for housing one or more pouch cells, the pouch cell enclosure comprising:
first and second walls that are spaced apart in a cell stack direction so as to define a cell-receiving space therebetween for receipt of one or more pouch cells;
a spring arrangement comprising a first end at the second wall and a second end extending into the cell-receiving space to engage one or more pouch cells when received in the cell receiving space, the spring arrangement being compressible from an expanded configuration to a compressed configuration in which the distance between the first and second ends of the spring arrangement is reduced in the cell stack direction, and
wherein the spring arrangement comprises a resilient spring element configured to bend in response to compression of the spring arrangement and to bias the spring arrangement towards the expanded configuration.

One problem that is inherent in the use of foam is that it is only able to compress to a certain strain for a given cell expansion. In other words, at maximum compression of the foam (being maximum expansion of the cell(s)), the foam still has some residual thickness. This residual thickness must be accounted for in the overall dimension of the battery in the cell stack direction, resulting in a larger battery (at least in the cell stack direction). This issue is exacerbated by the fact that pouch cell batteries typically contain a plurality of cells in a stack with several layers of foam.

Another potential problem with the use of foam is that at least some types of foam material are susceptible to decomposition in thermal runaway events. A thermal runaway event occurs when a battery reaches an elevated temperature, causing a chain reaction that ultimately results in a very rapid rise in the temperature of the battery. Not only is decomposition of the foam undesirable but, in some cases, the use of foam between cells can also increase the likelihood of reaching those elevated temperatures because it can act as an insulator.

The spring arrangement (and the spring element) of the first aspect removes the need to use foam in the enclosure. This can result in an enclosure of reduced dimension in the cell stack direction (as will be described further below). Likewise, the removal of foam can reduce the likelihood of a cell reaching the elevated temperatures required for a runaway event, because (in the absence of the foam layers) heat is able to be transferred from the cell to any surrounding cells and/or the enclosure.

Accordingly, the pouch cell enclosure of the first aspect may be more compact (at least in the cell stack direction) and may be less likely to undergo a thermal runaway event.

Optional features of the first aspect will now be set out. These are applicable singly or in any combination with any aspect.

The expanded configuration of the spring arrangement may be the natural position of the spring arrangement.

The spring arrangement may comprise a plurality of spring elements. Each spring element may be configured to bend in response to compression of the spring arrangement and to bias the spring arrangement towards the expanded position.

The plurality of spring elements may be arranged in an array on a reference plane that extends across the cell-receiving space, perpendicular to the cell stack direction (the reference plane may e.g. extend across the entirety of the cell-receiving space). Providing an array of spring elements may allow the force provided by the spring arrangement to be distributed across the cell-receiving space (e.g. across the pouch cell engaged by the second end of the spring arrangement). This may reduce the pressure applied to a pouch cell at any one point.

The spring elements may be arranged in a regular pattern across the reference plane. The array of spring elements may comprise one or more rows of evenly spaced spring elements. Again, this may aid in the distribution of force.

The plurality of spring elements may be distributed substantially evenly (e.g. may be substantially evenly spaced) across the reference plane.

The spring arrangement may be compressible to a configuration in which the first and second ends of the spring arrangement are substantially co-planar along a plane that is substantially perpendicular to the cell stack direction. By being compressible to such a configuration the spring arrangement can be compressed to a configuration (e.g. the compressed configuration) in which it has substantially no residual thickness (or at least less residual thickness than would be the case with a foam layer). This may provide a battery enclosure of smaller volume (providing higher energy density). As may be appreciated, while the spring arrangement may be compressible to such a configuration, this may not necessarily always occur in practice (i.e. in normal use). This is because such a position may represent a maximum compression of the spring arrangement, and this may only occur at maximum (allowable) expansion of the pouch cells. Such maximum expansion may not always occur in practice (but it may nevertheless be desirable to accommodate such expansion in case of its occurrence).

The spring arrangement may be compressible to a configuration (e.g. the compressed configuration) in which each of the one or more spring elements substantially extends along a reference plane that is perpendicular to the cell stack direction. Thus, each spring element may be compressible from a position in which it extends out of plane with respect to the reference plane to a position in which it is in-plane. Again, this may aid in minimising the volume of the pouch cell enclosure.

The spring arrangement may comprise a plate element. The plate element may extend substantially perpendicularly to the cell stack direction. Each spring element may be in engagement with or integral with the plate element. The abovementioned reference plane may be defined by a surface of the plate element. The one or more spring elements may extend from only one side of the plate (i.e. the opposite side of the plate may be substantially free of spring elements and may thus be substantially planar).

Thus, each spring element may be connected to one another to form portions of a single piece (e.g. may be connected by the plate element). This may facilitate assembly of the pouch cell enclosure (e.g. ensuring that a desired positioning/spacing of the spring elements is maintained).

In some embodiments, each spring element may be integral with, and may extend from, the plate element. Thus, the plate element and spring elements may form a single unitary piece.

Each spring element may be provided adjacent to a respective recess formed in the plate element, and each spring element may be received at least partly in the respective recess when compressed. Each spring element may be a cut-out portion of the plate element (which may be bent out of plane with the plate element in the expanded configuration). The one or more spring elements and the plate element may be formed from a stamped metal sheet. This may minimise the complexity (and e.g. cost) of forming the spring arrangement.

In some embodiments the plate element may form at least part of the second wall. The plate element may provide the second wall. In other words, the one or more spring elements may be integrally formed with the second wall. Each of the one or more spring element may be compressible to a position in which the spring element is substantially in-plane with respect to the second wall (i.e. co-planar with the second wall). As described above, this may be achieved, for example, by forming each spring element via a stamping process.

By providing each spring element as part of the second wall, each spring element may be compressible to the second wall such that the residual volume of the biasing arrangement may be zero or close to zero. In other words, the spring arrangement may, when in a fully compressed position, not take up any space within the pouch cell enclosure (because the spring arrangement may be contained within the second wall).

The plate element may be a first plate element and the spring arrangement may comprise a second plate element. The second plate element may be arranged so as to be between the one or more spring elements and the one or more pouch cells when received in the cell-receiving space. In such embodiments, each spring element may extend from the first plate element to the second plate element. In this way, the second plate element may act to distribute the force applied by the spring arrangement to the one or more pouch cells. This may avoid areas of high pressure which could, for example, result in puncture of the flexible pouch of a pouch cell. Each spring element may be fixed to or may simply be in contact with the second plate element.

In some embodiments (e.g. such as those that do not necessarily include a second plate element), the above-described plate element (e.g. the first plate element) may be arranged so as to be between the one or more spring elements and the one or more pouch cells. In such embodiments, each spring element may extend from the plate element toward the second wall (e.g. for contact with the second wall).

At least one of the spring elements may be a leaf spring or a compression spring (e.g. conical compression spring). In some embodiments all of the spring elements may be a leaf spring or a compression spring (e.g. conical compression spring).

Each spring element may comprise an elongate member having a proximal end mounted (e.g. integral with) to the plate element and a distal free end (e.g. may be in the form of a tab). Each elongate member may be rectangular. Alternatively, each elongate member may taper inwardly from the proximal end to the distal end (e.g. may have a triangular shape). This may reduce root stress (at the proximal end) and provide a substantially constant stress ratio along the length of the elongate member.

Each leaf spring may, for example, be in the form of a linear or curved elongate member extending out of plane (i.e. with respect to the reference plane or plate as described above) from a fixed end to a free end. Each conical compression spring may, for example, be in the form of a helical element extending out of plane in a helical shape. Each spring

In some embodiments, the one or more spring elements and the plate element may be separate parts. In such embodiments, the plate element may comprise one or more locating features configured to cooperate with each of the one or more spring elements to restrict movement of the each of the one or more spring elements. Such restriction of movement may, for example, be in a direction along a reference plane that is perpendicular to the cell stack direction.

Each of the one or more of the spring elements may be in the form of a so-called Belleville washer (i.e. a washer having a frustoconical shape with a central hole therethrough).

The first and second walls of the enclosure may be substantially planar (and may be parallel to one another). The enclosure may comprise lateral sidewalls that are spaced either side of the cell-receiving space and that extend between (and connect) the first and second walls. The enclosure may have a substantially cuboid shape. Opposite ends of the enclosure may be open for access to the terminals of pouch cells when received in the cell-receiving space.

In some embodiments, the pouch cell enclosure may be provided with more than one spring arrangement. For example, a further spring arrangement may be provided that has a first end at the first wall and a second end extending into the cell-receiving space to engage a pouch cell received in the cell-receiving space. The further spring arrangement may be the same as the spring arrangement described above (i.e. may include one or more option features of the spring arrangement described above). In such embodiments, the one or more pouch cells may be received between the spring arrangement and further arrangement and both spring arrangements may accommodate expansion and contraction of the pouch cell(s) in use.

The enclosure may comprise one or more internal walls that divide the cell-receiving space into a plurality of regions (or form a plurality of cell-receiving spaces). For example, the enclosure may comprise one or more internal walls that extend laterally across the internal space of the enclosure (between the sidewalls), and that may be parallel to the first and second walls (such a wall may be referred to as a strut). Alternatively, the enclosure may comprise an internal wall that extends between (and connects) the first and second walls. In each case, at least one spring arrangement may be provided in each region (or each cell-receiving space) to accommodate expansion and contraction of the pouch cell(s) received therein.

In some embodiments the second wall may be an internal wall of the enclosure (e.g. may be a strut). In other words, the spring arrangement may be provided between a strut and pouch cells received in the cell-receiving space.

In any of the above-described embodiments, at least one of the first and second walls may comprise a fastener for mounting an external component to the first or second wall. The fastener may comprise a head pressed into the first wall such that the first or second wall is deformed around the fastener to retain the fastener in the first or second wall. The fastener may comprise a shaft extending from the head so as to project from, and beyond, the outer surface of the first or second wall. The shaft or head of the fastener may comprise (e.g. radially or axially extending) teeth. Deformed material may be received between the teeth. The shaft or head of the fastener may comprise a recess extending circumferentially (e.g. fully) around the shaft or head. Deformed material may be received in the recess. The shaft of the fastener may be threaded. The head of the fastener may be fully received within the first or second wall (i.e. may not project therefrom).

In a second aspect, there is disclosed a battery comprising:
one or more pouch cells; and
a pouch cell enclosure comprising:
   first and second walls that are spaced apart in a cell stack direction so as to define a cell-receiving space therebetween in which the one or more pouch cells are received;
   a spring arrangement comprising a first end at the second wall and a second end extending into the cell-receiving space to engage a pouch cell of the one or more pouch cells, the spring arrangement being compressible from an expanded configuration to a compressed configuration in which the distance between the first and second ends of the spring arrangement is reduced in the cell stack direction, and
wherein the spring arrangement comprises a resilient spring element configured to bend in response to compression of the spring arrangement and to bias the spring arrangement towards the expanded configuration.

The battery of the second aspect is advantageous for the same reasons as discussed above with respect to the first aspect. That is, the battery of the second aspect may be more compact (at least in the cell stack direction) and may be less likely to undergo a thermal runaway event.

Optional features of the second aspect will now be set out. These are applicable singly or in any combination with any aspect.

The pouch cell enclosure of the second aspect may be as described above with respect to the first aspect. For example, the pouch cell enclosure may include one or more of the optional features of the first aspect described above.

Each pouch cell may have opposite first and second major faces, which may respectively face towards the first and second compression members. The major faces of each pouch cell may be substantially perpendicular to the cell stack direction. The layers of an internal layered structure of each pouch cell may be substantially parallel to the major faces of the pouch cell.

Each pouch cell may comprise opposite lateral sides (e.g. aligned with the lateral sides of the enclosure) and may comprise opposite ends. Each pouch cell may comprise at least two terminals, which may be at the same end or at opposite ends of the pouch cell.

### BRIEF DESCRIPTION OF THE DRAWINGS

FIG. 1A is a section view of a battery according to a first embodiment in which a spring arrangement of an enclosure of the battery is in an expanded configuration;

FIG. 1B is a section view of the battery of FIG. 1A in which the spring arrangement is in a compressed configuration;

FIG. 1C is a perspective view of a spring arrangement of the battery of FIG. 1A;

FIG. 2 is a perspective view of a spring arrangement of a battery according to a second embodiment;

FIG. 3 is a perspective view of a pouch cell enclosure for a battery according to a third embodiment;

FIG. 4A is a perspective view of a pouch cell enclosure for a battery according to a fourth embodiment;

FIG. 4B is a perspective view of a spring arrangement of the pouch cell enclosure of FIG. 4A;

FIG. 5A is a section view of part of a battery according to a fifth embodiment;

FIG. 5B is a perspective view of a spring element of the battery of FIG. 5A; and

FIG. 6 is a section view of a battery according to a sixth embodiment.

### DETAILED DESCRIPTION

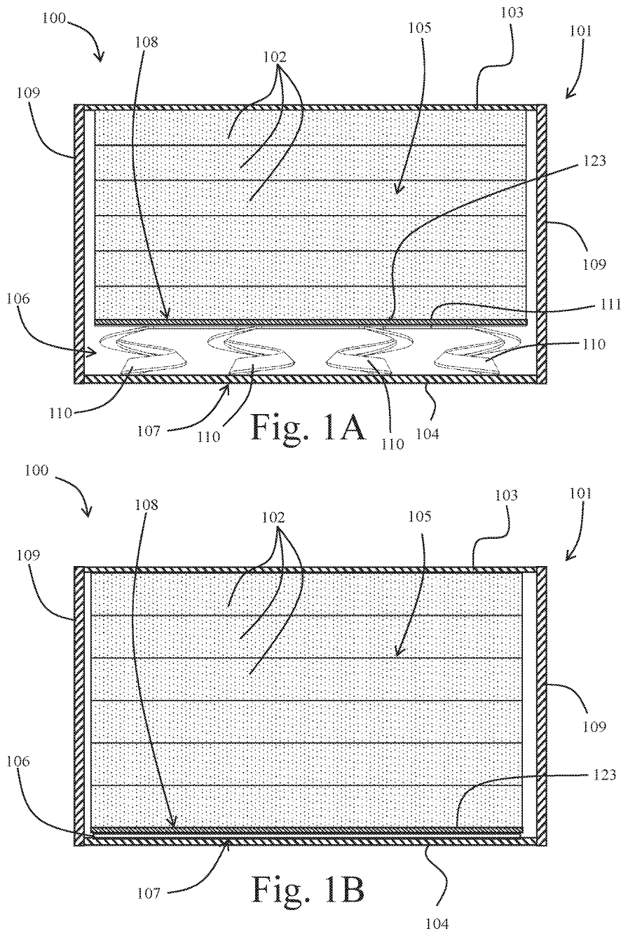

FIGS. 1A and 1B illustrate a battery 100 that includes a pouch cell enclosure 101 and six pouch cells 102. The pouch cell enclosure 101 includes first 103 and second 104 walls (which are upper and lower walls as illustrated) that are spaced apart in a cell stack direction (vertical as illustrated) so as to define a cell-receiving space 105 therebetween. The pouch cells 102 are disposed within this cell-receiving space 105 so as to be retained (and compressed) between the first 103 and second 104 walls.

The pouch cell enclosure 101 also includes two sidewalls 109 on opposite sides of the cell-receiving space 105, and which extend (vertically as illustrated) between the first 103 and second 104 walls. In this way, the pouch cell enclosure 101 has a substantially rectangular cross-sectional shape (i.e. the cross-section taken in the same plane as the section of FIGS. 1A and 1B). Although not apparent from the figure, the pouch cell enclosure 101 (and the cell-receiving space 105) has a substantially cuboid shape.

Each pouch cell 102 also has a generally cuboid shape, with opposite major faces (upper and lower faces as illustrated) that face the first 103 and second 104 walls of the pouch cell enclosure 101. Each pouch cell 102 also includes a plurality of internal layers (not shown) that are substantially parallel to the major faces of the pouch cell 102 and that provide the energy storage function of the pouch cell 102.

The pouch cell enclosure 101 further includes a spring arrangement 106 comprising a first end 107 at the second wall 104 and a second end 108 that extends into the cell-receiving space 105. In this way, the second end 108 of the spring arrangement 106 engages one of the two outermost (in this case the lowermost) pouch cells 102 of the stack of pouch cells 102.

The spring arrangement 106 is compressible from an expanded configuration (as shown in FIG. 1A) to a compressed configuration (as shown in FIG. 1B) in which the distance between the first 107 and second 108 ends of the spring arrangement 106 is reduced in the cell stack direction. The spring arrangement 106 is moved from the expanded configuration to the compressed configuration in use by expansion of the pouch cells 102 (which typically occurs throughout the charge cycles of the pouch cells).

The spring arrangement 106 is shown alone in FIG. 1C. As is apparent from this figure, the spring arrangement 106 comprises a plurality of resilient spring elements 110. Each spring element 110 is configured to bend in response to compression of the spring arrangement 106, and to bias the spring arrangement 106 towards the expanded configuration. This bias of the spring elements 110 thus provides a compressive force for compression of the pouch cells 102 between the spring arrangement 106 and the first wall 103.

The spring arrangement 106 further includes a substantially planar plate element 111 which is substantially parallel to the first 103 and second 104 walls. The spring elements 110 extend from the plate element 111 (in the expanded configuration) to the second wall 104. Compression of the spring arrangement 106 thus results in compression of each spring element 110 towards the plate element 111.

The spring elements 110 are distributed substantially evenly across the plate element 111. In particular, the spring elements 110 are distributed in four rows of twelve spring elements 110 that form a grid-like array of spring elements 110 distributed across the plate element 111. This substantially even distribution of spring elements 110 aids in distributing the force applied to the pouch cell 102 which is engaged by the spring arrangement 106.

In the illustrated embodiment, each spring element 110 has a helical (or corkscrew) shape so as to be in the shape of a conical compression spring. That is, each spring element 110 is formed of an elongate member 112 that extends along a helical (of constantly reducing radius) path to a free distal end 113 that is distal from the plate element 111 (at least in the expanded configuration).

As should be apparent from FIG. 1C in particular, each spring element 110 is integrally formed with the plate element 111 such that the spring elements 110 and the plate element 111 form a unitary piece. In particular, the spring elements 110 and plate element 111 are formed from stamped sheet metal. One result of this is that each spring element 110 is compressible to a position in which the spring element 110 is substantially coplanar with the plate element 111 (i.e. such that the elongate member 112 lies in a single plane). This position is apparent from FIG. 1B (in which the thickness of the spring arrangement 106 is effectively the thickness of the plate element 111). As already discussed above, this minimises the volume required for provision of the spring arrangement 106 and thus minimises the overall volume of the enclosure 101.

To further aid in the distribution of force across the lowermost pouch cell 102, a planar force distribution plate 123 is provided between the plate element 111 and the pouch cells 102. The force distribution plate 123 is in contact with substantially the entirety of the lower major surface of the lowermost pouch cell 102 to distribute force (from the spring element 110) across the lower surface of the lowermost pouch cell 102. As may be appreciated, in some embodiments the plate element 111 may provide sufficient force distribution (and, if so, the force distribution plate 123 may be omitted). While including such a distribution plate 123 can result in some residual thickness when the spring elements 110 are fully compressed (i.e. being the thickness of the plate 123), this is typically less than would be the case with the use of foam.

It should be appreciated that in a variation of the embodiment shown in FIGS. 1A, 1B and 1C, the orientation of the spring arrangement 106 could be reversed such that the plate element 111 lies against the second wall 104 and the spring elements 110 project towards the lowermost pouch cell 102 (although such an arrangement may provide less effective distribution of force on the pouch cells 102 than the illustrated arrangement). In such embodiments, a force distribution plate may be provided or omitted.

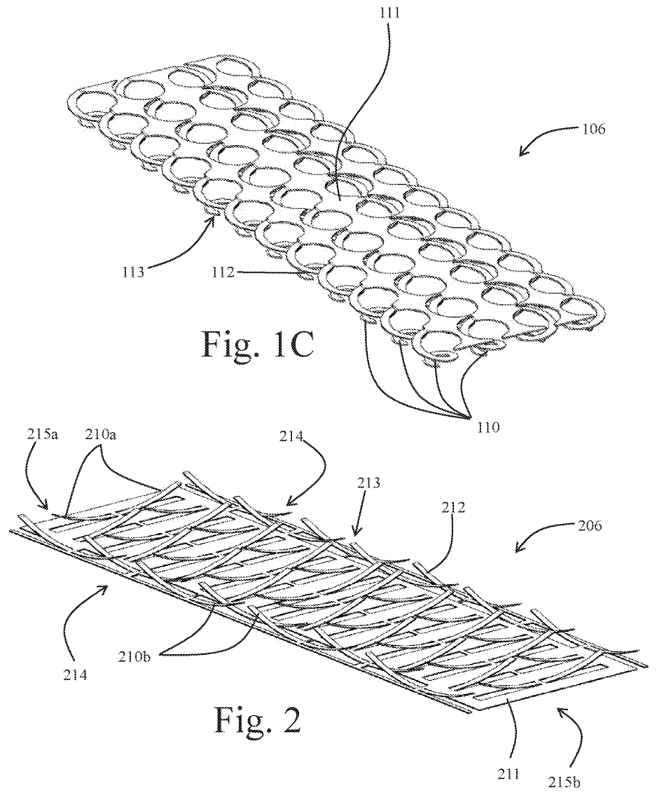

It should also be appreciated that the spring elements 110 may take various other forms. One such variation is illustrated in FIG. 2. The spring arrangement 206 of FIG. 2, includes a plate element 211 and a plurality of spring elements 210a, 210b that are distributed substantially evenly across the plate element 211, and that extend out of plane from one side of the plate element 211. Again, the spring arrangement 206 of FIG. 2 is formed of stamped metal sheet (so as to be a unitary piece).

Each spring element 210a, 210b is in the form of a leaf spring, which consists of an elongate member 213 extending out of plane from the plate element 211 along a curved path to a free distal end 213 (the curved path lying in a single plane that is substantially perpendicular to the plate element 211).

The spring arrangement 206 includes a set of first spring elements 210a that extend in a width direction of the plate element 211 (would extend in a direction between the sidewalls of an enclosure in use), and a set of second spring elements 210b that extend in a length direction of the plate element 211 (would extend between ends of an enclosure in use).

The first spring elements 210a are arranged in pairs. The pairs of first spring elements 210a are spaced apart in the length direction to form a row of pairs of first spring elements 210a. The pairs of spring elements 210a alternate (in a direction along the row) between each spring element 210a of the pair extending out of plane and away from one another, and both spring elements 210a extending out of plane towards one another.

The second spring elements 210b are also arranged in pairs. In particular, two rows of second spring element 210b pairs are provided, each row provided along a respective lateral side 214 of the plate element 211. In each pair of second spring elements 210b one of the second spring elements 210b extends out of plane towards a first end 215a of the plate element 211 and the other of the pair extends out of plane towards an opposite second end 215b of the plate element 211.

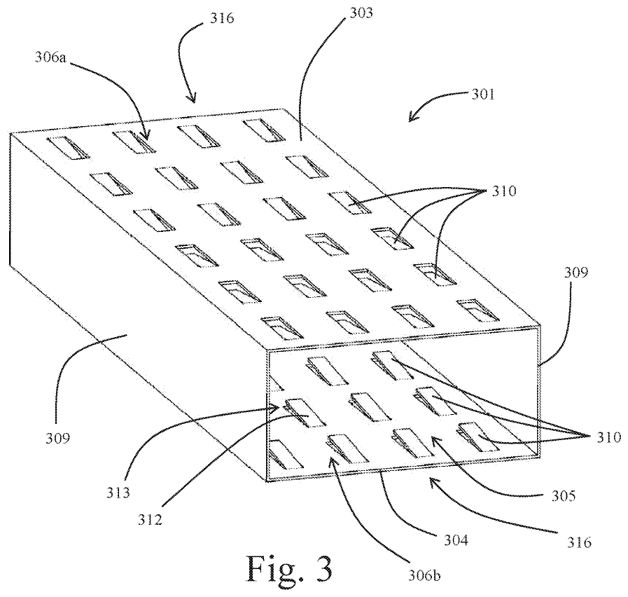

FIG. 3 illustrates a further variation of a pouch cell enclosure 301. The enclosure 301 includes first 303 and second 304 walls spaced apart in a cell stack direction to define a cell-receiving space 305 therebetween. The cell-receiving space 305 is also bounded by opposite sidewalls 309 that extend between the first 303 and second 304 walls.

Unlike the previously described embodiments, the presently illustrated enclosure 301 includes first 306a and second 306b spring arrangements. The first spring arrangement 306a includes a plate element that is provided by the first wall 303 and a plurality of spring elements 310 that extend out of plane from the first wall 303 into the cell-receiving space 305. The second spring arrangement 306b includes a plate element that is provided by the second wall 304 and a plurality of spring elements 310 that extend out of plane from the second wall 304 into the cell-receiving space 305.

The spring elements 310 of each spring arrangement 306a, 306b are distributed substantially evenly across their respective wall 303, 304 in a grid-like array. Each spring element 310 is in the form of a leaf spring. In particular, each spring element 310 is formed of an elongate member 312 extending out of plane along a substantially linear path from a respective wall 303, 304 to a free distal end 313. Accordingly, each spring element 310 is generally in the form of a planar tab that is partially cut out of the wall 303, 304 and bent out of plane.

On each of the first 303 and second 304 walls, the spring elements 310 are arranged such that each spring element 310 extends from the wall 303, 304 towards an end 316 of the enclosure 301 that is furthest from the spring element 310. Thus, each spring element 310 is oriented so as to extend in a length direction of the enclosure 301 (i.e. a direction extending between the ends), with half of the spring elements 310 extending towards one end 316 and half extending towards the other end 316.

Each spring element 310 provides a restoring (bias) force when pushed towards its respective wall 303, 304. As may be appreciated from the figure, when pouch cells are received in the cell-receiving space 305, the distal ends 313 of the spring elements 310 of the first wall 303 bear against the uppermost pouch cell (in the orientation illustrated) and the distal ends 313 of the spring elements 310 of the second wall 304 bear against the lowermost pouch cell. In this way, a compressive force can be applied to a stack of pouch cells received in the cell-receiving space 305 by the first 306a and second 306b spring arrangements of the enclosure 301 as the pouch cells expand and contract in use.

While not illustrated, it should be appreciated that force distribution plates may be provided between the spring elements 310 and pouch cells received in the cell-receiving space 305 (e.g. one force distribution plate for each of the first 303 and second 304 walls.

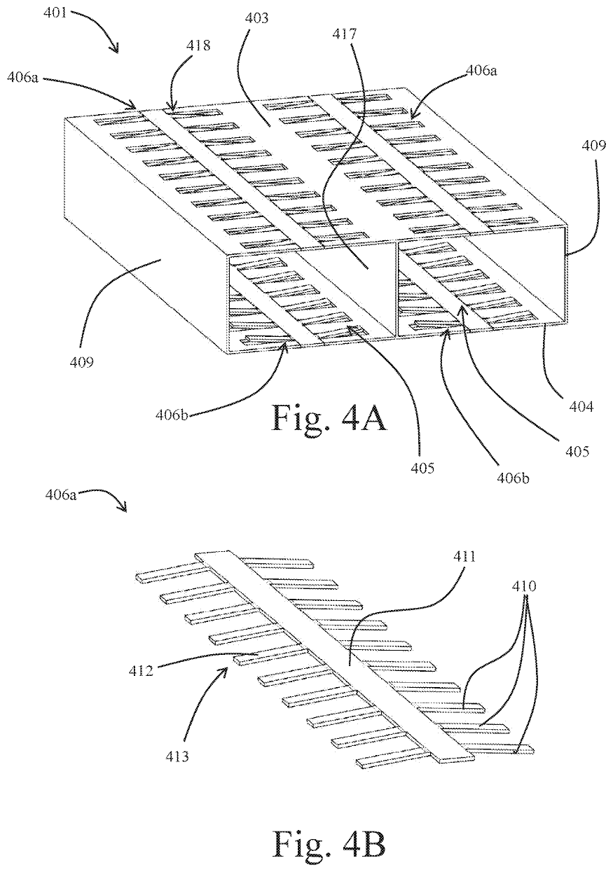

FIG. 4 shows a further pouch cell enclosure 401, which is similar to that shown in FIG. 3. Again, the pouch cell enclosure 401 includes first 403 and second 404 walls connected by sidewalls 409 to form a substantially cuboid shape. The enclosure further includes a central internal wall 417 interposed between the sidewalls 409 and, again, connecting the first 403 and second 404 walls. The central internal wall 417 forms two cell-receiving spaces 405 arranged in a side-by-side manner.

Each of the cell-receiving spaces 405 is provided with two spring arrangements 406a, 406b for applying a compressive force to pouch cells when received therein (i.e. in the same manner as the embodiment of FIG. 3). For each cell-receiving space 405, one of the spring arrangements 406a extends into the respective cell-receiving space 405 from the first wall 403 and the other spring arrangement 406b extends into the respective cell-receiving space 405 from the second wall 404.

Unlike the embodiment of FIG. 3, the spring arrangements 406a, 406b of the presently illustrated enclosure 401 each include a plate element 411 that is separate to (but affixed to) the wall 403, 404 from which the spring arrangement 406a, 406b extends. An exemplary spring arrangement 406a (which is formed as a unitary piece) is shown in more detail in FIG. 4B. The plate element 411 is elongate so as to be in the form of a spine, from which a plurality of spring elements 410 extend laterally outwardly on opposite sides of the plate element 411. Each spring element 410 is a leaf spring having an elongate member 412 integral with the plate member 411 and extending out of plane from the plate member 411 to a free distal end 413 along a substantially linear path (i.e. each spring member 410 is substantially planar).

Returning to FIG. 4A, the plate member 411 of each spring arrangement 406a, 406b is fixed within a respective recess 418 of a respective wall 403, 404. Each recess 418 is shaped for receipt of a respective plate member 411 and for receipt of the spring elements 410 when the respective spring arrangement 406a, 406b is compressed. In other words, each recess 418 has a shape that includes a central spine (in which a plate member 411 is received) and a plurality of laterally extending fingers that receive spring elements 410 when they are compressed by expansion of pouch cells received in the cell-receiving spaces 405.

Again, while not shown, it should be appreciated that force distribution plates may be provided to distribute force from the spring element 410 to pouch cells received in the cell-receiving spaces 405.

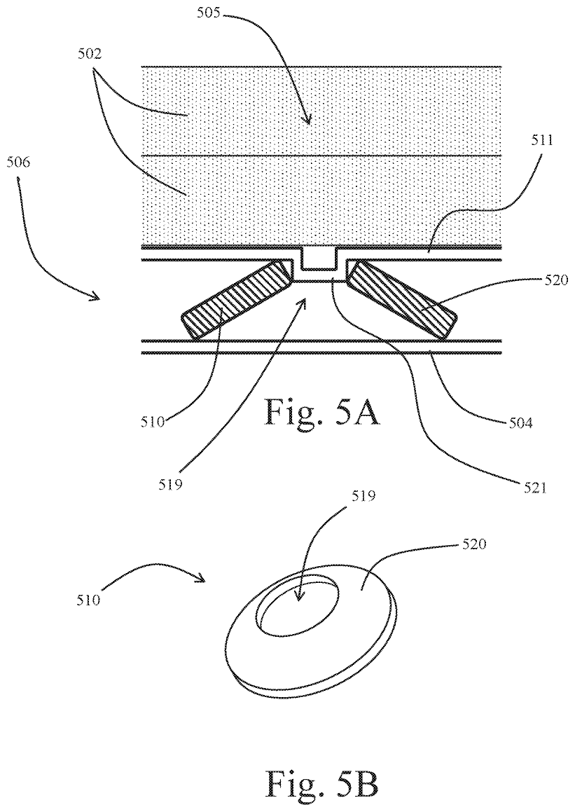

FIGS. 5A and 5B illustrate part of a spring arrangement 506 that may be provided as part of a pouch cell enclosure (e.g. may replace the spring arrangements of the previously described pouch cell enclosures).

The spring arrangement 506 is provided between a second wall 504 of an enclosure and a plurality of pouch cells 502 received in a cell-receiving space 505. The spring arrangement 506 includes a plate member 511 and a plurality of spring elements 510 (although only one is shown). The plate member 511 bears against the lowermost pouch cell 502 and helps to distribute a restoring force applied by the spring elements 510. Each spring element 510 is in the form of a Belleville washer. One such spring element 510 is shown in FIG. 5B. The spring element 510 includes an annular frustoconical wall 520 defining a central hole 519 formed therein. As the spring element 510 is compressed, the frustoconical 520 wall is deformed so as to flatten (i.e. becomes more planar). The spring element 510 provides a restoring force as it attempts to return to its natural (non-flattened) shape.

To retain each spring element 510 against movement in the lateral direction (i.e. against movement in a plane substantially parallel to the second wall 404), the plate element 511 includes a plurality of locating features 521, in the form of protrusions, that are received in the central holes 519 of the spring elements 510.

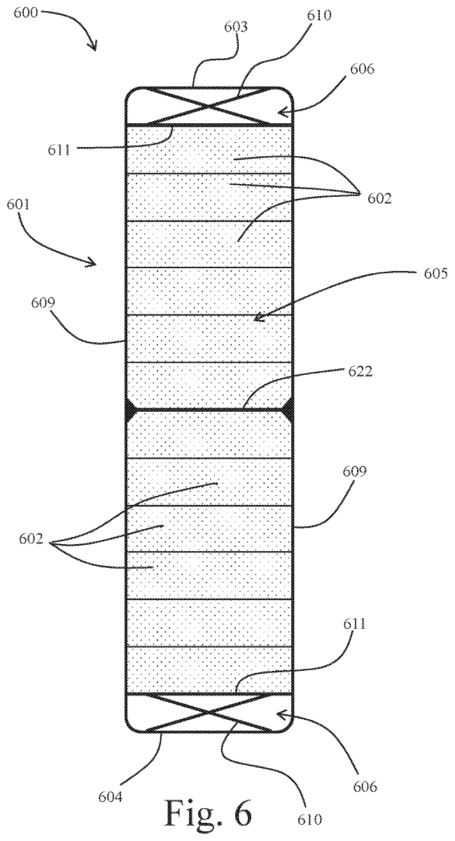

FIG. 6 depicts a battery 600 according to a further embodiment. The battery 600 includes a pouch cell enclosure 601 housing two stacks, each of six pouch cells 602. The pouch cell enclosure 601 includes first 603 and second 604 walls spaced apart in a cell stack direction to define a cell-receiving space 605 therebetween, and spaced opposite sidewalls 609. The cell-receiving space 605 is divided into two regions (each stack of pouch cells 602 being received in a respective region) by a planar strut 622 extending laterally across the cell-receiving space 605 between the sidewalls 609. The strut 622 is fixed to each of the sidewalls 609 so as to provide a rigid internal plate against which the pouch cells bear in use.

Although the battery 600 is depicted in an orientation whereby the walls 603, 604, pouch cells 602 and strut 622 extend horizontally, the battery 600 may instead be oriented such that these features of the battery 600 extend substantially vertically (i.e. such that the battery is rotated 90 degrees from its illustrated orientation).

The pouch cell enclosure 601 further includes two spring arrangements 606, each provided at a respective one of the first 603 and second 604 walls. Each spring arrangement 606 includes a planar plate member 611 that extends between the sidewalls 609 and that functions to distribute force applied to the pouch cells 602.

Each spring arrangement 606 also includes one or more spring elements 610 (depicted schematically). In general, each spring element 610 may take any form that is compressible in the cell stack direction from an expanded configuration to a compressed configuration while also providing a restoring force against such compression. For example, each spring element 610 may be in the form of a compression spring (e.g. a conical compression spring).

In other embodiments (not illustrated), spring arrangements 606 (or additional spring arrangements) could be positioned between the strut 622 and respective pouch cells.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A battery comprising:
one or more pouch cells; and
a pouch cell enclosure comprising:
first and second walls that are spaced apart in a cell stack direction so as to define a cell-receiving space therebetween in which the one or more pouch cells are received; and
a spring arrangement comprising a first end at the second wall and a second end extending into the cell-receiving space to engage a pouch cell of the one or more pouch cells, the spring arrangement being compressible from an expanded configuration to a compressed configuration in which the distance between the first and second ends of the spring arrangement is reduced in the cell stack direction,
wherein the spring arrangement comprises a resilient spring element configured to bend in response to compression of the spring arrangement and to bias the spring arrangement towards the expanded configuration.

2. The battery according to claim 1, wherein the spring arrangement comprises a plurality of spring elements, each configured to bend in response to compression of the spring arrangement and to bias the spring arrangement towards the expanded configuration.

3. The battery according to claim 2, wherein the plurality of spring elements are arranged in an array on a reference plane that extends across the cell-receiving space, perpendicular to the cell stack direction.

4. The battery according to claim 3, wherein the array comprises one or more rows of evenly spaced spring elements.

5. The battery according to claim 1, wherein the spring arrangement is compressible to a configuration in which the first and second ends of the spring arrangement are substantially co-planar along a plane that is substantially perpendicular to the cell stack direction.

6. The battery according to claim 1, wherein the spring arrangement is compressible to a configuration in which each of the one or more spring elements substantially extends along a reference plane that is perpendicular to the cell stack direction.

7. The battery according to claim 1, wherein the spring arrangement comprises a plate element extending substantially perpendicularly to the cell stack direction, the one or more spring elements in engagement with or integral with the plate element.

8. The battery according to claim 7, wherein the one or more spring elements are integral with, and extend from, the plate element.

9. The battery according to claim 8, wherein the one or more spring elements and the plate element are formed from a stamped metal sheet.

10. The battery according to claim 7, wherein the plate element forms at least part of the second wall.

11. The battery according to claim 10, wherein the plate element is a first plate element and the spring arrangement comprises a second plate element arranged so as to be between the one or more spring elements and the one or more pouch cells.

12. The battery according to claim 7, wherein the plate element is arranged so as to be between the one or more spring elements and the one or more pouch cells.

13. The battery according to claim 1, wherein each of the one or more spring elements is a leaf spring or a conical compression spring.

14. The battery according to claim 7, wherein the one or more spring elements and the plate element are separate parts, and wherein the plate element comprises one or more locating features configured to cooperate with each of the one or more spring elements to restrict movement of the each of the one or more spring elements in a direction along a reference plane that is perpendicular to the cell stack direction.

15. The battery according to claim 14, wherein each of the one or more spring elements is a Belleville washer.

16. A pouch cell enclosure for housing one or more pouch cells, the enclosure comprising:
first and second walls that are spaced apart in a cell stack direction so as to define a cell-receiving space therebetween for receipt of the one or more pouch cells; and
a spring arrangement comprising a first end at the second wall and a second end extending into the cell-receiving space to engage one or more pouch cells when received in the cell-receiving space, the spring arrangement being compressible from an expanded configuration to a compressed configuration in which the distance between the first and second ends of the spring arrangement is reduced in the cell stack direction,
wherein the spring arrangement comprises a resilient spring element configured to bend in response to compression of the spring arrangement and to bias the spring arrangement towards the expanded configuration.
